(19) United States
(12) Patent Application Publication
(10) Pub. No.: US 2006/0220958 A1
(43) Pub. Date: Oct. 5, 2006

(54) Antenna element and array antenna

(76) Inventor: Atle Saegrov, Trondheim (NO)

Correspondence Address: CHRISTIAN D. ABEL, ONSAGERS AS, POSTBOKS 6963 ST. OLAVS PLASS, NORWAY, N-0130, NO

(21) Appl. No.: 10/542,588

(22) PCT Filed: Jan. 23, 2004
(86) PCT No.: PCT/NO04/00019

§ 371 Date: Sep. 19, 2005

(30) Foreign Application Priority Data
Jan. 23, 2003 (NO) 20030347

(51) Int. Cl. H01Q 1/38; H01Q 1/36

(52) U.S. Cl. 343/700 MS; 343/895

(57) ABSTRACT

An antenna element for an array antenna comprises a transmission line (1) passed through a ground plane (3), connected at an excitation point (8) to a flat, conductive, helical excitation element (6) mounted on a dielectric substrate (4) on the top of and parallel to the ground plane (3). The distance between the excitation element (6) and the ground plane (3) is greater than one eight of the longest wavelength of the signals with which the antenna is arranged to operate, and preferably between 0.25 and 0.50 times the wavelength. The path length of the electric conductor that constitutes the excitation element is greater than the said wavelength, and preferably between 10 and 100 times the wavelength. This causes the excitation element to operate as a leakage wave structure, with the result that the antenna element becomes non-resonant. An array antenna is further described with a number of such antenna elements arranged in a square matrix configuration, where a common ground plane (3) and a common substrate (4) are employed. A dielectric lens (7) is mounted on the top of the antenna element or the array antenna.

### TECHNICAL FIELD

The invention relates to an antenna element, particularly an antenna element for use in electrically controlled array antennas employed in the field of location determination or optimisation of traffic capacity in wireless communication systems. The invention also relates to an array antenna in which the antenna element is incorporated, together with an application of the array antenna.

### BACKGROUND OF THE INVENTION

In wireless communication systems there are some situations where there is a need to locate the mobile and stationary communication units with great accuracy. There is also a need for more intelligent use of the physical layer in the communication model in order to increase the capacity and availability in the available frequency bands where the density of users is high.

In this connection an apparatus has previously been developed for location determination, described in international patent application WO-01/30099, belonging to the applicant. The solutions described therein are hereby incorporated by reference.

An apparatus has also been previously developed for increasing the channel capacity between mobile units and between the mobile units and a stationary unit, described in international patent application WO-02/87096, belonging to the applicant. The solutions described therein are hereby incorporated by reference.

Both of these types of apparatus typically contain, or entail the use of, a matrix of antennas, i.e. an array antenna. A crucial factor for the performance of such apparatus is the design of the antenna elements in the array antenna. This applies particularly to indoor applications, where reflections and dispersion are salient effects. For such short-range communication applications it is also important to be able to process signals with low angles of incidence relative to the surface represented by the antenna, and it is important that the antenna's radiation pattern out towards these boundary conditions is changed as little as possible.

### THE STATE OF THE ART

From U.S. Pat. No. 6,407,721 a technique is described where several helical antennas and a resonant ground plane are employed to obtain an antenna structure which is particularly thin while at the same time having broadband properties. Helical antennas in the form of single-armed or double-armed antennas are structures which are otherwise generally known.

From U.S. Pat. No. 5,589,842 a technique is known where the helical antenna is placed on top of a magnetic material in order to reduce the physical size of the antenna while at the same time preserving the broadband properties.

From U.S. Pat. No. 5,508,710 a technique is known where a helical antenna is combined with a resonant loop antenna in order to obtain a compact antenna structure which can service several frequency bands.

From U.S. Pat. No. 5,621,422 a technique is known where a balanced two-armed helical antenna is short-circuited at the ends of the spiral in order to obtain a broadband structure which is compact in size.

The common feature of all these previously known antenna types is that they have frequency-limiting elements which give complex radiation patterns, with a resultant disturbance of the homogeneous field over a considerable frequency range. There is therefore a need for an antenna structure which also has homogeneous field and polarisation characteristics for large drive angles θ. The known technique involving reactive elements or interconnected elements is particularly unsuitable for systems in the locating systems or array systems domain requiring a high degree of conformity between the elements. There is therefore a need to produce an antenna which has good broadband properties while at the same time having small irregularities in radiation pattern and polarisation direction—particularly at large angles of incidence θ.

### SUMMARY OF THE INVENTION

An object of the invention is to provide an antenna element which is improved in comparison with previously known solutions, and which is particularly suitable for locating the source of an incoming electromagnetic wave front with great accuracy.

A further object is to provide such an antenna element which has the best possible electromagnetic connection properties and at the same time the lowest possible implementation/production costs.

Another object of the invention is to provide an improved array antenna in which such an antenna element is incorporated.

Furthermore, it is an object of the invention to provide an antenna element and an array antenna which are suitable for use in an apparatus for location determination as described in WO-01/30099, or in an apparatus for capacity increase, where a physical communication channel has to be established from the apparatus to a mobile unit, or between two mobile units via the apparatus, or from a stationary unit via the apparatus to different mobile units, as described in WO-02/87096.

Yet another object is to provide an antenna element and an array antenna which are particularly suitable for indoor use, where problems usually arise connected with extremely complex propagation environments. Here the signals are usually exposed to reflections/multipath, dispersion and polarisation change.

According to the invention the above objects are achieved with an antenna element as indicated in the independent claim 1, and with an array antenna as indicated in the independent claim 11. The invention also comprises an application as indicated in the independent claim 15. Further objects and advantageous characteristics are achieved by the features indicated in the dependent claims.

A special, advantageous feature of the antenna element according to the invention is that it is not resonant, but based on the leakage wave principle. This means that the electromagnetic field is converted to current along the conductor as the signal travels along the excitation element in the antenna element. Consequently, an array antenna composed of such antenna elements can be used over several octaves—for example from 1-10 GHz or 1-60 GHz, without the efficiency in the antenna or the relative phase shift between the elements being affected. For traditional antenna types such as monopole, dipole or patch antennas, the resonant characteristic will cause the poles in the different antennas which have scatter as a function of inaccuracies in length to have a significant influence on the radiation pattern and the phase differences measured in the antennas particularly towards the boundaries for the operating range of the antenna. The antenna element and the array antenna according to the invention are non-resonant, and therefore do not have poles and zero points that are characteristic of resonant antennas These characteristics are particularly advantageous for antennas intended for operation on several frequency bands, for example on 2.45 GHz and 5.3 GHz. The radiation pattern for a resonant antenna on 2.45 GHz such as a monopole will be different on 5.3 GHz, while for a leakage wave antenna according to the invention the radiation pattern will be approximately the same, given that the length of the antenna is also a sufficient multiple of wavelengths on the lowest frequency.

These characteristics are particularly important for implementing localization of radio sources according to IEEE 802.11b which operates in the frequency band 2.4-2.5 GHz, and IEEE 802.11a, which are usually combined in the same unit, and which operates in the frequency bands 5.25-5.35 GHz and 5.725-5.825 GHz. The invention is therefore optimal for covering all of these three frequency bands without the antenna structure having different radiation patterns and with undesirable zero points for the different frequency bands. These special characteristics form the basis for this antenna structure having been selected for localization purposes.

The antenna element and the array antenna may advantageously be implemented on a flat and cost-effective laminate, such as FR4, where each excitation element is composed of a printed circuit pattern (a conductor path) on one side. This laminate is normally employed for the cost-effective circuit board implementations, but this low-cost laminate is also suitable for frequencies up to over 5 GHz and up to 60-70 GHz when the antenna structure is implemented according to the present invention. An antenna element and an array antenna according to the invention, moreover, make limited demands on accuracy in the production process.

The broadband properties of the antenna element according to the invention permit the antenna element to be used in many different wireless applications, thus enabling different applications in different frequency bands to be operated with the same antenna element.

The antenna element is particularly well suited for implementation of an array antenna since the insulation between adjacent elements is good—generally more than 30 dB. This is an important feature for avoiding array antenna effects which will degrade precision in the localization process—particularly at large angles of incidence θ. Another unique feature of the antenna is that a dielectric lens is employed for increasing the conformity of the radiation field and the polarisation characteristics for larger angles of incidence θ. Another unique feature of the invention is that the phase centre in the antenna is a function of the direction angle φ. This characteristic assists in enabling an array antenna to utilise this property in order to favour signals from a specific direction, φ. This characteristic is not present, for example, in a monopole, dipole or patch antenna which are common antenna types for such array antennas. A limiting factor in classic array antennas is the disadvantages which arise at large angles of incidence θ. When this angle increases, desirable characteristics such as antenna amplification are reduced, the polarisation is distorted and the relative phase shift between the antenna elements is no longer constant. By introducing a dielectric lens, it becomes possible to compensate for polarisation rotation and loss in antenna amplification on the sides. Consequently, a change in the angle θ for the incident signal results in a smaller relative phase shift between the antenna elements, but this is compensated by the system being capable of calculating more accurate directions of incidence for smaller θ than for large θ.

Further objects and advantages of the invention will be apparent from the following description with drawings. Identical elements are indicated by the same reference designations in the drawings.

### BRIEF DESCRIPTION OF THE DRAWINGS

The invention will now be described in greater detail in the form of preferred embodiments with reference to the drawings, in which

FIG. 1A is a schematic cross sectional view of the antenna element,

FIG. 1B is a schematic cross sectional view of an excitation sleeve,

FIG. 2 is a schematic top view of an antenna structure,

FIG. 3 is a schematic top view of an antenna structure incorporated in an array antenna, in which the antenna element is incorporated,

FIG. 4 is a schematic perspective view of an antenna structure,

FIG. 5 is a schematic cross sectional view indicating several details of the antenna element,

FIGS. 6A-D are various schematic top views of alternative embodiments of the antenna element,

FIG. 7 is a schematic cross sectional view of an array antenna.

### DETAILED DESCRIPTION OF PREFERRED EMBODIMENTS

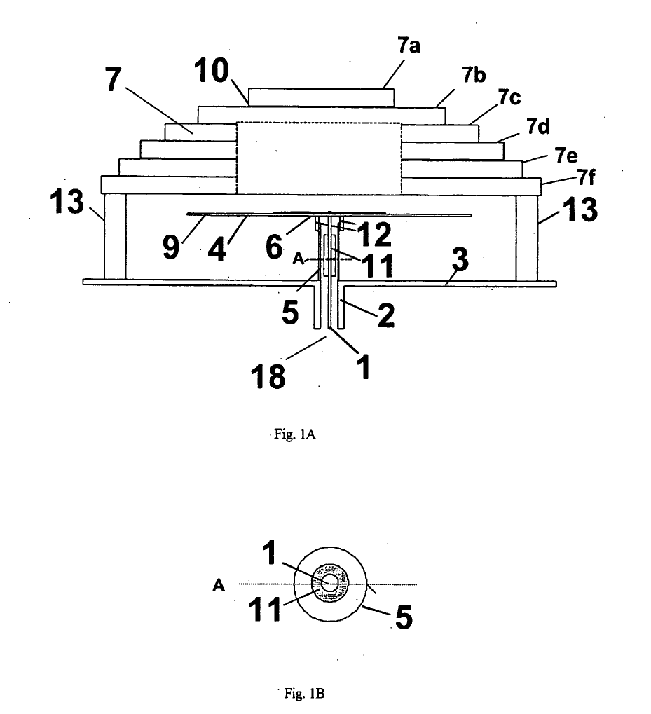

FIG. 1A is a schematic cross sectional view of the antenna element, viewed from the side. A metallic centre conductor 1 is arranged to pass a signal from a connection point 18 to an excitation element 6. The centre conductor 1 extends in an axially centred manner through a cylindrical transmission line jacket 2 and through an aperture in a ground plane 3. The centre conductor 1 extends further in an axially centred manner through a cylindrical excitation sleeve 5. The section of the centre conductor 1 that extends through the excitation sleeve 5 advantageously comprises an impedance matching element 11 for matching the high impedance in the antenna to a standard 50Ω system which will be connected to the connection point 18. The impedance matching element 11 may be implemented as a cylinder of a dielectric with a high dielectric constant, which encloses the centre conductor 1, and which is further enclosed by the excitation sleeve. Alternatively, the impedance matching may be implemented by having a section of the centre conductor 1 in the form of a spiral. In the latter case the height of the excitation sleeve 5 can be reduced.

The excitation sleeve 5 is terminated at a distance below an excitation point 8 where the centre conductor 1 is connected to the excitation element 6.

A cylindrical insulating sleeve 12 made of a dielectric material, for example Teflon, is placed on the outside of the upper portion of the excitation sleeve 5 in such a manner that the insulating sleeve 12 projects above the excitation sleeve's upper termination and up to a substrate 4 that supports the excitation element. The insulating sleeve 12 thereby ensures that a suitable distance is maintained between the excitation element 6 and the excitation sleeve 5.

The excitation element 6 is composed of a flat conductor path, preferably of copper, fixed to the top of a flat substrate 4 made of a dielectric material such as glass fibre FR4.

The excitation element 6 and the substrate 4 together form an antenna structure 9. The antenna structure 9 thereby assumes the form of a printed circuit board, which may advantageously be manufactured by well-known production techniques for circuit boards such as impressing, imprinting, growth or engraving.

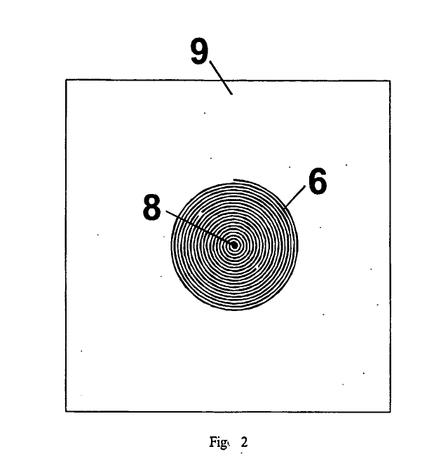

The excitation element 6 is preferably helical in form, as will be apparent below under the description of FIG. 2. The innermost end portion of the excitation element 6 is electrically connected to the centre conductor 1 at the excitation point 8, preferably by soldering.

The distance between the excitation element 6 and the ground plane 3 is greater than one eighth of the longest wavelength for the signals with which the antenna is arranged to operate. A specially preferred distance is between a quarter and a half of the said wavelength. Furthermore, the path length of the electric conductor that constitutes the excitation element 6 is greater than one such wavelength. A specially preferred path length is between 10 and 100 times the wavelength. These features cause the antenna element 6 to operate as a leakage wave structure.

In the embodiment in FIG. 1A, on the top of the antenna structure 9 there is mounted a dielectric lens 7 made of a plastic material such as Teflon or plexiglass. The function of the lens 7 is to improve the antenna's lateral characteristics. The dielectric lens is preferably implemented as a number (illustrated:6) of discs 7a, 7b, 7c, 7d, 7e, 7f of different shapes and/or sizes, placed on top of one another. It is specially preferred for each disc to be circular, and the discs to be of the same thickness, but with different diameters. The discs are mounted with a common axis and arranged so that the diameter of the discs decreases in the direction facing away from the antenna structure 9, the smallest therefore being at the uppermost part of the lens, as illustrated in FIG. 1A. The lens 7 as a whole is arranged in such a manner that the axis of the discs coincides with the centre point 8 of the antenna structure 9.

The above disc construction for the lens 7 results in a cost-effective implementation, but also offers further technical advantages. In particular, discs with different dielectric characteristics can be combined. In the embodiment illustrated in FIG. 1A, for example, the three top discs can be made of materials with a low dielectric constant, while the three bottom discs 7d, 7e, 7f can be made of a material with a high dielectric constant. The result of this is that for large angles of incidence θ, the desired characteristics can be achieved with regard to increased conformity of the radiation field between different antenna structures in an array antenna. Furthermore, in an array antenna system where this solution is employed, for example in a localization application, increased angular resolution will be obtained for large angles of incidence θ.

The flexibility of implementation achieved by means of the disc construction can provide better characteristics with regard to the desired controllable radiation pattern. In order to implement a lens in a uniform material, the material would have to be milled relatively deeply in order to achieve the correct refraction of the electromagnetic wave front. The lens could have been moulded, but the preparation of a mould of this size for injection moulding or the like is expensive. The disc structure is therefore favourable with regard to production costs, since simple milling and stamping techniques can be employed in production instead of deep milling, complex casting moulds or complex machining.

The electric lens 7 may be supported by spacers 13 in a dielectric material such as Teflon. Alternatively, the lens 7 may be supported by side walls 13 of a metallic material in order to prevent undesirable radiation exposure for large angles of incidence θ. This alternative is particularly favourable in cases where the output from the dielectric lens is required to be the dominant characteristic.

FIG. 1B is a schematic cross sectional view of the excitation sleeve 5, taken at the dotted line indicated by A in FIGS. 1A and 1B. It can be seen that the axial centre conductor 1 is enclosed by the matching network 11 and there is a space between the matching network 11 and the inner wall of the excitation sleeve 5.

FIG. 2 is a schematic top view of an antenna structure illustrating the construction of the antenna structure, viewed from above. A copper conductor path 6 in the form of an Archimedes spiral is applied to a dielectric laminate 9 such as the cost-effective glass fibre material FR4, the spiral's radius being a linear function of the absolute angle during an imaginary rotation around the centre point 8. This centre point 8 is the point which is electrically connected to the inner conductor 1 and which is the excitation point in the antenna structure.

The helical form causes the antenna element to be circularly polarised. This has the advantage of avoiding distortion of linear polarisation affecting the signals, thus causing them to be attenuated in the antenna.

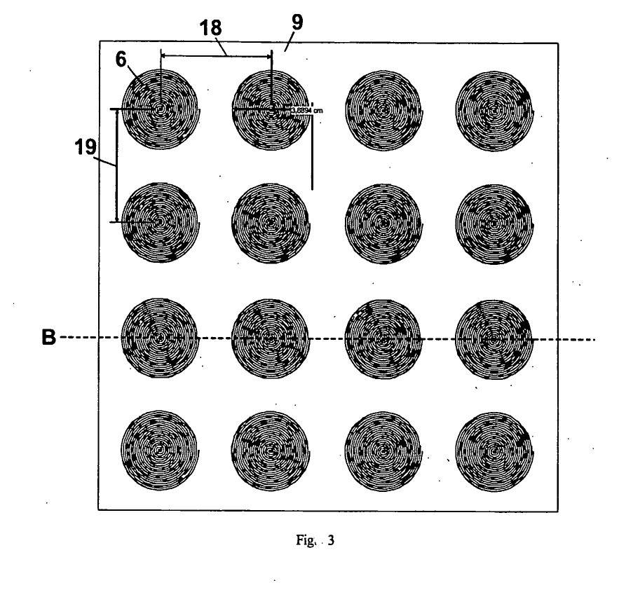

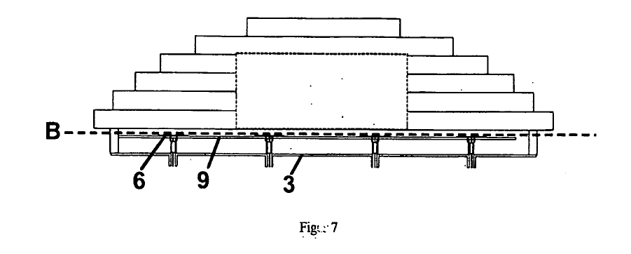

FIG. 3 is a schematic top view of an antenna structure incorporated in an array antenna in which the antenna element is incorporated. The array antenna, for example, comprises 16 excitation elements, only one of which is indicated by reference numeral 6. The 16 excitation elements 6 in the form of copper paths are applied to a common dielectric laminate 4 made of the cost-effective material FR4. Each excitation element 6 is helical in form in the same way as is illustrated in FIG. 2, and the excitation elements are arranged in a square 4×4 matrix configuration. The laminate 4 and the excitation elements 6 together form an array antenna structure in the form of a circuit board 9. A cross section taken along the intersecting line B is described below with reference to FIG. 7.

The distances 18, 19 between the centres of adjacent excitation elements are preferably identical, and of the order to 54 mm where the array antenna has to operate at a frequency of 2.45 GHz.

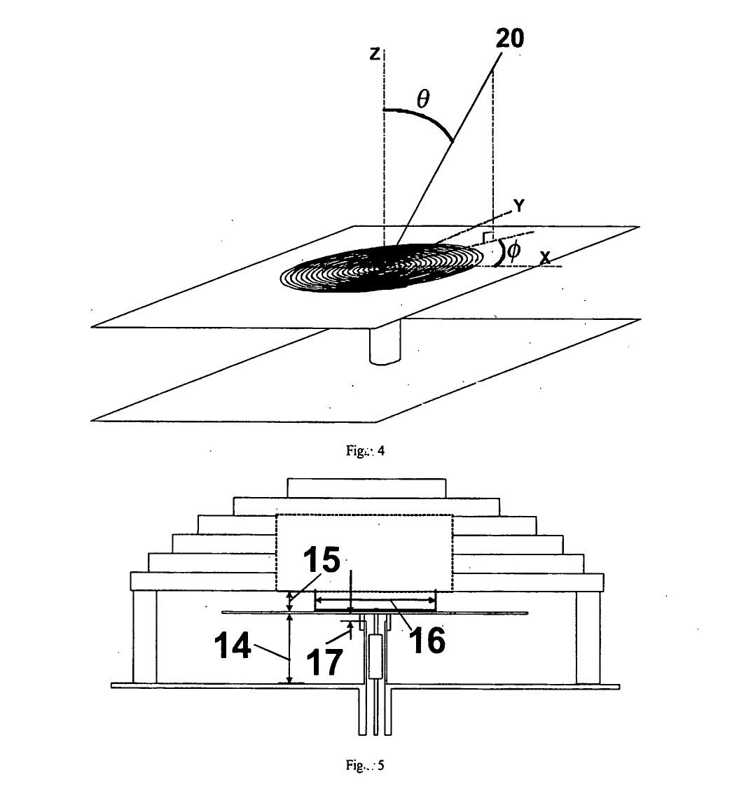

FIG. 4 is a schematic perspective view of an antenna structure 9, where the angles φ and θ are defined. The angle φ is the angle between the plane defined by the x-axis and the z-axis and the direction for an incident wave 20 as illustrated in FIG. 4. The angle θ is the angle of incidence between the z-axis (perpendicular to the antenna element's principal plane) and the direction for the incident wave 20.

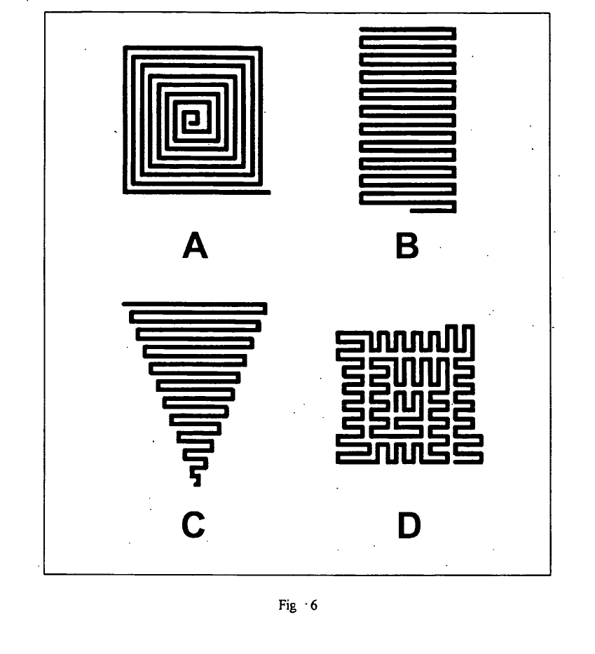

FIG. 5 illustrates in a cross sectional view the same embodiment as in FIG. 1, with the indication of further details. As can be seen, the antenna structure or circuit board 9, comprising the substrate 4 and the excitation element 6, is raised to a relatively high level above the ground plane 3. The vertical distance between the antenna structure 9 and the ground plane 3 is indicated by reference numeral 14, and this distance is at least ⅛ of the longest wavelength for the signals with which the antenna is arranged to operate. The distance 14 is preferably between 0.25 and 0.5 times this wavelength.

For an antenna for use at 2.45 GHz the distance 14 is advantageously approximately 25 mm, and the path length is advantageously approximately 1300 mm. Furthermore, the antenna structure 9 is raised above the excitation sleeve 5 by a distance 17, which for the same frequency range is preferably approximately 1.5 mm. The vertical distance 15 between the upper part of the antenna structure and the lower surface of the dielectric lens 7 is typically between 1 mm and 3 mm. The distance 15 should be provided depending on the dielectric lens's dielectric constant. If the dielectric constant of the lens is relatively small (<3), the distance can be made very short (<1 mm). Otherwise a distance of 2-3 mm may be suitable.

The diameter of the excitation element is dependent on the total path length of the conductor path forming the spiral. It is desirable to avoid standing waves, and hence extra poles and degradation of the circular polarisation characteristics. In order to achieve this, the length of the conductor path should be approximately 10 wavelengths or more. For an antenna employed at 2.45 GHz, the path length for the electric conductor will advantageously be 1.3 metres or more. For an antenna in this frequency range, a suitable diameter 16 will be approximately 38 mm. The thickness of the electric path that constitutes the spiral is not particularly critical. In the present example the thickness of the electric path is 0.3 mm.

FIG. 6 illustrates alternative embodiments of the excitation element 6.

It will be appreciated that the circular polarisation may be produced by a number of alternatives to the purely helical pattern structure described in the above. Within the scope of the invention, antennas with linear polarisation may also be implemented by employing other geometrical shapes. The leakage wave structure will still be preserved.

At A a rectilinear, right-angled helical shape is illustrated. An excitation element designed in this manner will give circular polarisation.

B illustrates a rectangular zigzag shape which will cause the excitation element to give linear polarisation.

C illustrates a variant of the embodiment indicated by B, where the width of the zigzag pattern increases approximately linearly with the distance from the excitation point. Such a shape will also give linear polarisation.

D indicates a complex leakage wave structure, comprising a square helical shape composed of a path with a rectangular zigzag shape. Such an embodiment will give linear polarisation or circular polarisation, depending on the details of the geometry.

FIG. 7 illustrates in cross section an example of an implementation of an array antenna structure according to the invention, where a number of antenna elements according to the invention are incorporated. The cross section is taken along the intersecting line B in FIG. 3.

As an example, the antenna elements are arranged in a 4×4, square matrix configuration. The illustrated cross section depicts 4 of a total of 4×4=16 excitation elements, only one of which is indicated by reference numeral 6.

In this embodiment a continuous, common ground plane 3 is employed, and a continuous, common laminate 4 is employed on which each excitation element 6 is mounted. In this case the antenna structure 9 is composed of the laminate 4 and all the excitation elements 6.

The electric lens 7 is mounted here above the array antenna as a whole. In other respects the lens 7 is designed in the same way as described with reference to FIG. 1A, but in this case the lens 7 is mounted in such a manner that the axis of the lens (i.e. the discs) coincides with a central point in the antenna structure 9.

Table 1 below indicates the advantageous distance between the excitation element and the ground plane and path length for the excitation element for different dimensional embodiments of the antenna element according to the invention. Each line in the table indicates one embodiment.

The first column indicates the frequency range at which the embodiment concerned is intended to work.

The second column indicates the corresponding range for the wavelength.

The third column indicates the least distance that must exist between the excitation element and the ground plane in order for the antenna element to behave as a leakage wave structure according to the invention.

The fourth column indicates the least path length for the excitation element in order for the antenna element to behave as a leakage wave structure according to the invention.

The fifth column indicates a specially preferred distance between the excitation element and the ground plane.

The sixth column indicates a specially preferred length of the excitation element.

TABLE 1

| | | | | | Most |
|---|---|---|---|---|---|
| | | | Least | Most | preferred |
| Frequency | | Least | path | preferred | path |
| range | Wavelength | distance | length | distance | length |
| (MHz) | (mm) | (mm) | (mm) | (mm) | (mm) |
| 225-400 | 1333.3-750.0 | 75 | 6667 | 100 | 9824 |
| 432-435 | 694.4-689.7 | 69 | 3472 | 100 | 4912 |
| 890-960 | 337.1-312.5 | 31 | 1685 | 50 | 2456 |
| 1710-1990 | 175-4-150.8 | 16 | 877 | 25 | 1228 |
| 2110-2170 | 142.2-138.2 | 15 | 811 | 25 | 1228 |
| 2400-2500 | 125.0-120.0 | 14 | 711 | 25 | 1228 |
| 5150-5350 | 58.3-56.1 | 12 | 625 | 25 | 1228 |
| 5725-5825 | 52.4-51.5 | 6 | 291 | 25 | 1228 |

Those skilled in the art will realise that many modifications and variations may be made within the scope of the invention. An array antenna according to the invention may, for example, contain a varying number of antenna elements, such as 3×3=9, 4×4=16 or 5×5=25. The array antenna, moreover, may be arranged in a different way than by means of a square matrix configuration. Materials and other construction details employed in the invention may furthermore be chosen and determined by those skilled in the art on the basis of what is described herein.

1. An antenna element for an array antenna for use in the field of location determination or optimisation of traffic capacity in wireless communication systems, where the said antenna element comprises a transmission line (1) passed through a ground plane (3), connected at an excitation point (8) to a first end portion of a flat, conductive excitation element (6) mounted on a dielectric substrate (4) on the top of and substantially parallel to the ground plane (3),
characterised in that
the distance between the excitation element (6) and the ground plane (3) is greater than one eighth of the longest wavelength of the signals with which the antenna is arranged to operate, and
the path length of the electric conductor that constitutes the excitation element is greater than the said wavelength, with the result that the antenna element operates as a leakage wave structure.

2. An antenna element according to claim 1,
where the said distance is greater than 1/10 of the said wavelength, and where the said path length is greater than 5 times the said wavelength.

3. An antenna element according to one of the claims 1-2,
where the excitation element (6) is arranged to provide circular polarisation, the excitation element (6) being in the form of a spiral, preferably an Archimedes spiral.

4. An antenna element according to one of the claims 1-3,
where the transmission line (1) is composed of a centre conductor which is passed axially through a cylindrical jacket (2) which is electrically connected to the ground plane (3).

5. An antenna element according to claim 4,
where the said centre conductor is further passed through a cylindrical excitation sleeve (5) which is electrically connected to the ground plane (3).

6. An antenna element according to claim 5,
where the said centre conductor is further passed through a cylindrical insulating sleeve (12) which projects beyond the excitation sleeve (5).

7. An antenna element according to claim 6,
where the said centre conductor is further passed through an aperture in the substrate (4), and further electrically connected to the excitation point (8) on the excitation element (6).

8. An antenna element according to one of the claims 1-7,
where the substrate (4) is made of glass fibre and the excitation element (6) is made of copper.

9. An antenna element according to one of the claims 1-8,
arranged to operate in a frequency band for global mobile communication such as GSM or UMTS, or in a frequency band for local mobile communication such as ISM-based systems on 433 MHz, Bluetooth/IEEE 802.11b/Hiperlan in the frequency range 2.4-2.5 GHz or IEEE 802.11a/Hiperlan in the frequency range 5-6 GHz.

10. An antenna element according to claim 9,
arranged to operate in the 2.45 GHz range,
where the excitation element is in the form of an Archimedes spiral,
where the said distance is in the interval 20 to 35 mm, and specially preferred of the order of 25 mm, and
where the said path length is in the interval 1000 mm to 1600 mm.

11. An array antenna,
characterised in that it comprises a number of antenna elements as indicated in one of the claims 1-10.

12. An array antenna according to claim 11,
where the antenna elements are arranged in a square matrix configuration,
where the antenna elements' ground plane (3) is common to the antenna elements,
where the antenna elements' substrate (4) is common to the antenna elements, and
where the common substrate (4) and the separate excitation elements (6) form an antenna structure (9) for the array antenna.

13. An array antenna according to claim 11 or 12,
where a dielectric lens (7) is mounted on the top of the excitation elements (6).

14. An array antenna according to claim 13,
where the lens (7) is composed of a number of cylindrical discs of dielectric material, and where the discs are arranged in such a manner that their diameter decreases in the direction away from the excitation elements (6).

15. Use of an array antenna according to one of the claims 11-14 as an antenna in an apparatus for location determination or in an apparatus for optimising traffic capacity in wireless communication systems.
